(19) United States
(12) Patent Application Publication
(10) Pub. No.: US 2020/0335987 A1
(43) Pub. Date: Oct. 22, 2020

(54) DUAL CHARGING STATION FOR GAME CONTROLLERS

(71) Applicant: ZhongShan Zen Factory Ltd., Zhongshan (CN)

(72) Inventor: Derek ZHENG, Zhongshan (CN)

(21) Appl. No.: 16/504,257

(22) Filed: Jul. 6, 2019

(30) Foreign Application Priority Data
Apr. 22, 2019 (CN) 201910324116.3

(51) Int. Cl. H02J 7/00

(52) U.S. Cl. CPC H02J 7/0044; H02J 2007/005; H02J 7/0047

(57) ABSTRACT

A dual charging station for game controllers, including a base and two power adapters. The base is configured for connecting a power supply, and is provided with a circuit board therein. Two grooves spaced apart are provided at a top of the base. A quick plug is provided at a bottom surface of the groove, and a quick socket is provided at a bottom surface of the power adapter. A top of the power adapter is provided with a charging plug. The quick plug is plugged into the quick socket corresponding to the quick plug. The dual charging station for game controllers is compatible with different game controllers.

### CROSS-REFERENCE TO RELATED APPLICATIONS

This application claims the benefit of priority from Chinese Patent Application No. 201910324116.3, filed on Apr. 22, 2019. The content of the aforementioned application, including any intervening amendments thereto, is incorporated herein by reference in its entirety.

### TECHNICAL FIELD

The present invention relates to a charging station for controllers, and more specifically to a dual charging station for game controllers.

### BACKGROUND OF THE INVENTION

PlayStation, released by Sony Computer Entertainment, is a series of home video game consoles. At present, the console of the PlayStation series has been developed to the fourth generation, and the fifth generation will be launched in 2020.

Game controllers in the PlayStation series are similar in appearance and size for every generation. Both fourth and fifth generation controllers have a Micro-B port and an Extended port, through which the game controllers are charged.

However, the fourth and fifth generation game controllers both adopt a built-in rechargeable battery. Due to a built-in vibration motor, the game controller has a vibration feedback during gaming, resulting in a serious power loss, so that the power of the game controller is not durable. There is a need for a simple charging station to charge the home video game consoles along with the fourth and fifth generation game controllers.

Although there are some game controller charging stations that are commercially available and can charge the fourth and fifth generation game controllers at the same time, this type of charging station is exclusively used for the corresponding game console model; that is, it can only charge one type of game controller, instead of all types of game controllers. When buying game controllers, users have to purchase a charging station matching them.

Therefore, the existing controller charging stations have low compatibility. For example, the charging station that matches the game controller of the fourth generation Play Station cannot charge that of the fifth generation Play Station, which bothers the users.

Therefore, a dual charging station for game controllers needs to be provided to solve the above technical problems.

### SUMMARY OF THE INVENTION

The present invention provides a dual charging station for game controllers, which is provided as two detachable parts, so different generations of game controllers can be charged by only replacing with power adapters in different shapes. The dual charging station for game controllers has a simple and firm structure, which is convenient for charging.

In order to solve the above technical problems, the technical solution adopted by the present invention is to provide a dual charging station for game controllers, comprising:

a base; and two power adapters.

The base is configured for connecting a power supply, and is provided with a circuit board therein. Two grooves spaced apart are provided at a top of the base. A quick plug is provided at a bottom surface of each of the two grooves. The circuit board is electrically connected to the quick plug.

The two power adapters are detachably inserted into the two grooves, respectively. A quick socket is provided at a bottom surface of the power adapter. A charging plug is provided at a top of the power adapter, and the quick plug is plugged into the quick socket corresponding to the quick plug.

In an embodiment, a first magnetic sheet is provided in the base and is located under each of the two grooves. A second magnetic sheet is provided on the bottom surface of each of the two power adapters, and the second magnetic sheet and the first magnetic sheet opposite to each other are attracted.

In an embodiment, the bottom surface of each of the two grooves is provided with a plurality of blind holes spaced apart and open upward. The first magnetic sheet is provided on a bottom surface of each of the plurality of blind holes. The second magnetic sheet is a magnetic cylinder provided on the bottom surface of each of the two power adapters, and a bottom of the magnetic cylinder is located in the blind hole corresponding to the magnetic cylinder.

In an embodiment, two blind holes in each of the two grooves are respectively arranged on both sides of the quick plug in a direction that is perpendicular to an arrangement direction of the quick plug.

In an embodiment, a rail groove transversely penetrates is provided at a top surface of the power adapter, and the charging plug facing upward is vertically provided on a bottom surface of the rail groove.

In an embodiment, an earphone plug is further provided at the bottom surface of the rail groove of the power adapter, and the earphone plug and the charging plug are arranged in a line on the bottom surface of the rail groove.

In an embodiment, an arrangement order of the charging plug and the earphone plug on one power adapter is opposite to that on the other power adapter. The two rail grooves extend in parallel with each other.

In an embodiment, the rail groove that transversely penetrates is provided at the top surface of the power adapter. The charging plug is located on an inner side wall of the rail groove, and the two rail grooves extend in parallel with each other.

In an embodiment, a bottom surface of the base is provided with an anti-slip pad respectively at four corners.

In an embodiment, a side wall of the base is provided with two charging indicator lights electrically connected to the circuit board. Each of the two charging indicator lights is configured to indicate a charging state of the corresponding power adapter. Another side wall of the base is provided with a power cable outlet hole through which the power cable passes.

This invention has the following beneficial effects. The signal conduction and the charge current between the base and the power adaptor are realized by plugging the quick plug into the quick socket, which is convenient to use. The charging station of the present invention can be compatible with the different generations of game controllers with different power adapters, so PlayStation fans have no need to purchase the dual charging station for game controllers of every generation of the game controller, which saves money for the gamers. In addition, the base and the power adapter are connected by magnetic attraction, avoiding the shaking phenomenon, so that the connection therebetween is firm and reliable.

### BRIEF DESCRIPTION OF THE DRAWINGS

FIG. 1 is a schematic diagram showing a dual game controller charging station according to a first embodiment of the present invention;

FIG. 2 is a front view of the dual game controller charging station in FIG. 1;

FIG. 3 is a rear view of the dual game controller charging station in FIG. 1;

FIG. 4 is a bottom view of the dual game controller charging station in FIG. 1;

FIG. 5 is an exploded view of the dual game controller charging station in FIG. 1;

FIG. 6 is a front view of a power adapter in FIG. 1;

FIG. 7 is a bottom view of the power adapter in FIG. 1;

FIG. 8 is a schematic diagram showing the dual charging station in FIG. 1 being connected to a controller of a fourth generation PlayStation console (Sony Company Entertainment) via an Extended port; and

FIG. 9 is a schematic diagram showing the dual charging station in FIG. 1 being connected to a controller of the controller of the fourth generation PlayStation console (Sony Company Entertainment) via a Micro-B port.

### DETAILED DESCRIPTION OF EMBODIMENTS

The technical solution of the present invention will be described below in detail with reference to the accompanying drawings.

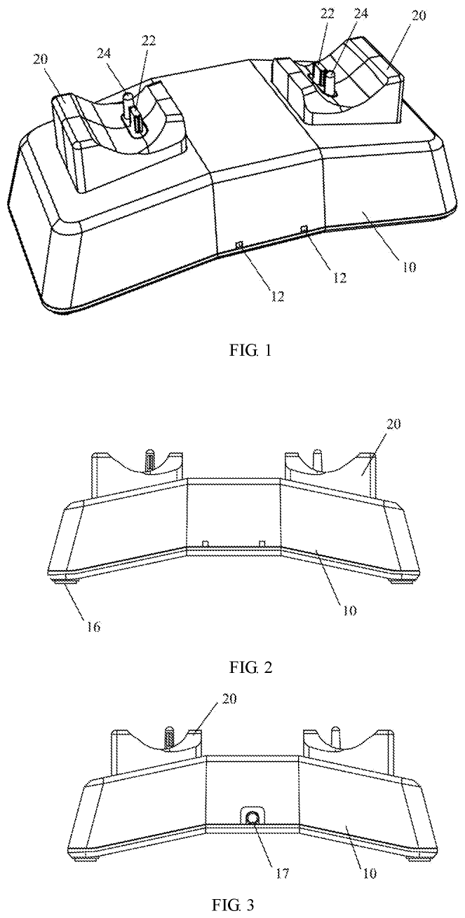

As shown in FIGS. 1-5, illustrated is a dual charging station for game controllers, comprising a base 10 and two power adapters 20.

The base is configured for connecting a power supply and is provided with a circuit board therein. As shown in FIG. 5, two grooves 13 spaced apart are provided at a top of the base 10, and a quick plug is provided at a bottom surface of each of the two grooves 13, and the circuit board is electrically connected to the quick plug 14.

As shown in FIGS. 1-3, the two power adapters 20 are detachably inserted into the two grooves 13, respectively. As shown in FIG. 7, a quick socket 21 is provided at a bottom surface of the power adapter 20. As shown in FIGS. 1 and 5, a charging plug 22 is provided at a top of the power adapter 20, and the quick plug 14 is plugged into the quick socket 21 corresponding to the quick plug.

In this embodiment, the quick plug 14 is a plug comprising a plurality of conductive pins or a flat-shaped goldfinger USB plug. The quick socket 21 accordingly matches with the quick plug 14.

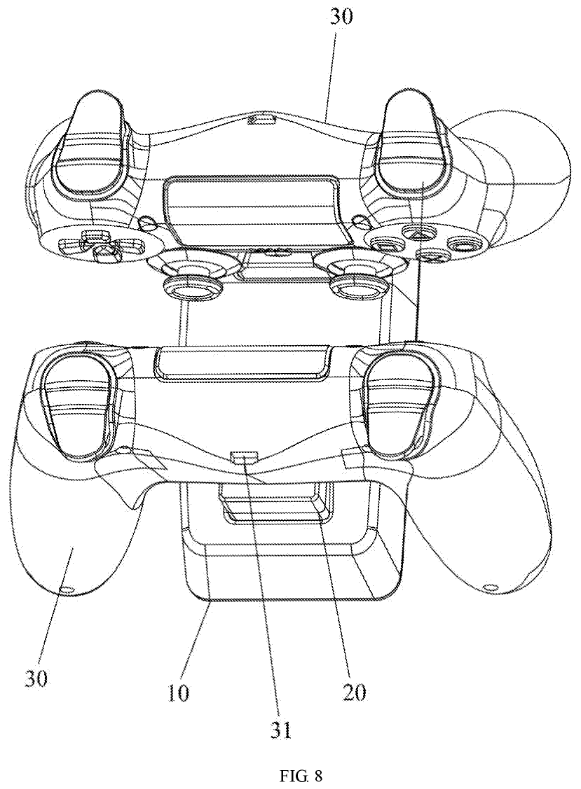

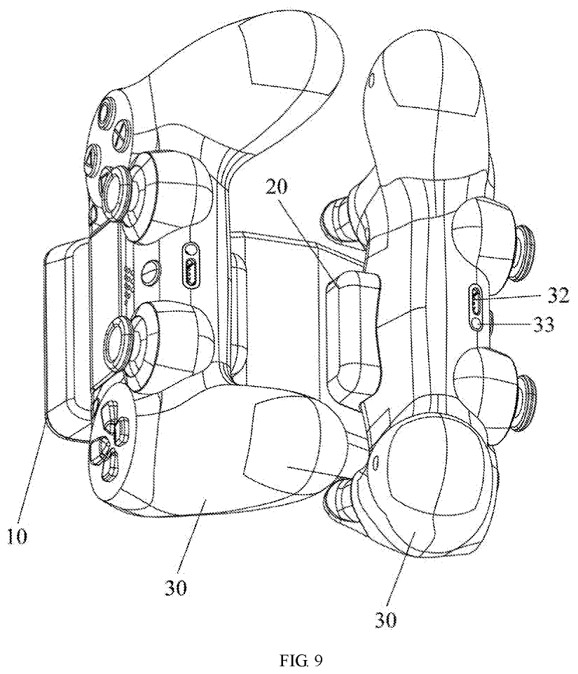

In this embodiment, the charging plug 22 is electrically connected to a Micro-B port 31 in FIG. 8 to charge a game controller 30 of a fourth generation PlayStation console (Sony Company Entertainment). As shown in FIG. 8, the charging plug 22 is electrically connected to the Micro-B port 31. The charging plug 22 is electrically connected to an Extended port 32 in FIG. 9 to charge the game controller 30. As shown in FIG. 9, the charging plug 22 is electrically connected to an Extended port 32. Specifically, the specific shape of the upper part of the power adapter 20 is selected according to a shape of a target charging port on the game controller. The shapes of the power adapters for the Micro-B port 31 and the Extended port 32 are different, and as shown in FIGS. 8-9, the fundamental difference is the shape of the charging plug 22 on the power adaptor 20.

In this embodiment, when the game controller 30 is being charged, the base 10 is electrically connected to the power supply, and then the charging plug is plugged into the charging port (the Micro-B port 31 or the Extended port 32) of the game controller, so that the gaming controller 30 is charged.

In this embodiment, the dual charging station for game controllers comprises two power adapters 20, thereby two game controllers 30 are charged at the same time.

In order to enhance the connection stability between the base 10 and the power adapter 20, in some embodiments, a first magnetic sheet is provided in the base 10 and is located under the groove 13. A second magnetic sheet is provided on the bottom surface of the power adapter 20, and the second magnetic sheet and the first magnetic sheet opposite to each other are attracted. In this embodiment, the power adapter 20 and the base 10 are electrically connected to each other in a plug-in connection, so magnetic attraction between the first magnetic sheet and the second magnetic sheet further strengthens the connection stability.

In this embodiment, the base 10 and the power adapter 20 are detachably connected for convenient disassembly and assembly. A suitable shape can be selected for the power adapter 20 according to the type of the game controller. Therefore, different types of the game controller can be charged without replacing the base 10.

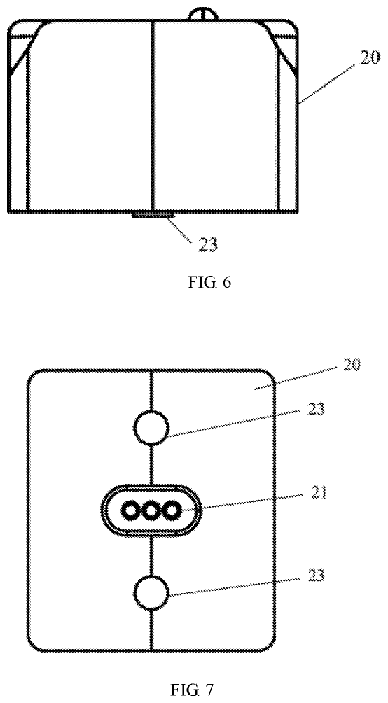

In an embodiment, as shown in FIG. 5, the bottom surface of the groove 13 is provided with a plurality of blind holes 15 spaced apart and open upward, and the first magnetic sheet is provided on a bottom surface of the blind hole 15. As shown in FIGS. 6-7, the second magnetic sheet is a magnetic cylinder 23 provided on the bottom surface of the power adapter 20, and a bottom of the magnetic cylinder 23 is located in the blind hole 15 corresponding to the magnetic cylinder. When the power adapter 20 is inserted into the groove 13 of the base 10, the magnetic cylinder 23 is inserted into the blind hole 15, so that the connection stability between the power adapter 20 and the base 10 is ensured. The magnetic cylinder 23 and the first magnetic sheet attract each other, which further enhances the connection stability between the power adapter 20 and the base 10.

As shown in FIG. 5, in an embodiment, two blind holes 15 in the groove 13 are respectively arranged on both sides of the quick plug 14 in a direction that is perpendicular to an arrangement direction of the quick plug 14. In some embodiments, the arrangement direction of the two blind holes 15 is not perpendicular to that of the quick plug 14, which is not limited herein.

In an embodiment, as shown in FIGS. 1 and 5, a rail groove that transversely penetrates is provided at a top surface of the power adapter 20, and the charging plug 22 facing upward is vertically provided on a bottom surface of the rail groove. In this embodiment, the specific shape of the rail groove depends on the shape of the game controller.

In this embodiment, as shown in FIGS. 1 and 5, an earphone plug 24 is further provided at the bottom surface of the rail groove of the power adapter 20, and the earphone plug 24 and the charging plug 22 are arranged in a line on the bottom surface of the rail groove. In this way, the game controller can be charged using the Extended port 32 as shown in FIG. 9.

In this embodiment, as shown in FIGS. 1 and 5, an arrangement order of the charging plug 22 and the earphone plug 24 on one power adapter 20 is opposite to that on the other power adapter 20. The two track grooves extend in parallel with each other, so that the two game controllers are arranged opposite to each other and are connected to the dual charging station for game controllers for charging.

As shown in FIGS. 8-9, the earphone plug 24 is inserted into an earphone port using the Extended port 32 and the earphone port 33 of the game controller 30 in FIG. 9, so that the charging plug 22 is inserted into the Extended port 32. In this embodiment, the earphone plug 24 is not configured for obtaining audio signals, but for improving the connection stability between the power adapter 20 and the corresponding game controller 30.

In an embodiment, as shown in FIG. 9, the rail grove that transversely penetrates is provided at the top surface of the power adapter 20. The charging plug 22 is located on an inner side wall of the rail groove, and The two rail grooves extend in parallel with each other. In this way, the game controller is charged by connecting the Micro-B port 31 on the game controller and the charging plug 22 on the power adapter 20.

In order to increase a friction between the base 10 and a support surface to prevent the base 10 from sliding relative to the support surface, in an embodiment, a bottom surface of the base 10 is provided with an anti-slip pad 16 respectively at four corners. In some embodiments, the number of anti-slip pad 16 is not limited.

As shown in FIGS. 1 and 5, in an embodiment, a side wall of the base 10 is provided with two charging indicator lights 12 electrically connected to the circuit board, and the charging indicator light 12 is configured to indicate a charging state of the corresponding power adapter 20. In this way, users can intuitively see the charging states of the two game controllers.

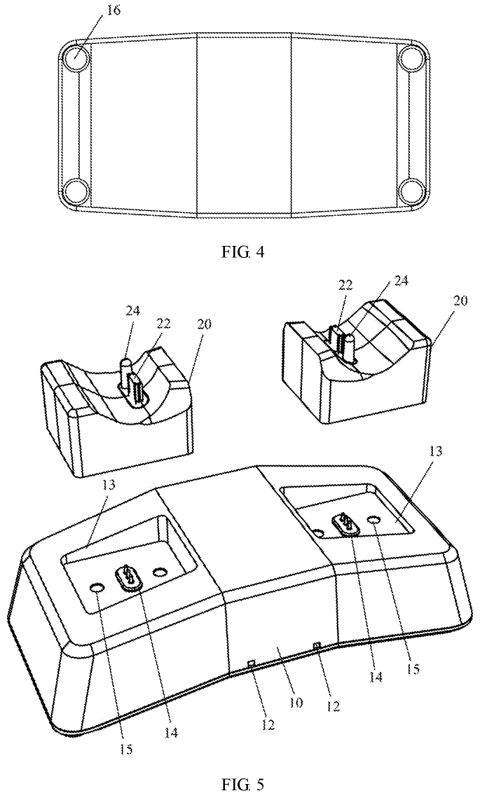

In an embodiment, as shown in FIG. 3, the side wall of the base 10 is provided with a power cable outlet hole 17 through which the power cable passes.

The above is only some embodiments of the present invention, but not intended to limit the scope of the present invention. Any equivalent structures on the basis of the description and the drawings of the present invention, or direct or indirect applications in other related technical fields, shall fall within the scope of the present invention.

What is claimed is:

1. A dual charging station for game controllers, comprising:
a base; and two power adapters;
wherein the base is configured for connecting a power supply and is provided with a circuit board therein; two grooves spaced apart are provided at a top of the base; a quick plug is provided at a bottom surface of each of the two grooves; and the circuit board is electrically connected to the quick plug;
the two power adapters are detachably inserted into the two grooves, respectively; a quick socket is provided at a bottom surface of the power adapter; a charging plug is provided at a top of the power adapter; and the quick plug is plugged into the quick socket corresponding to the quick plug.

2. The dual charging station of claim 1, wherein a first magnetic sheet is provided in the base and is located under each of the two grooves; a second magnetic sheet is provided on the bottom surface of each of the two power adapters; and the second magnetic sheet and the first magnetic sheet opposite to each other are attracted.

3. The dual charging station of claim 2, wherein the bottom surface of each of the two grooves is provided with a plurality of blind holes spaced apart and open upward; the first magnetic sheet is provided on a bottom surface of each of the plurality of blind holes; the second magnetic sheet is a magnetic cylinder provided on the bottom surface of each of the two power adapters, and a bottom of the magnetic cylinder is located in the blind hole corresponding to the magnetic cylinder.

4. The dual charging station of claim 3, wherein two blind holes in each of the two grooves are respectively arranged on both sides of the quick plug in a direction that is perpendicular to an arrangement direction of the quick plug.

5. The dual charging station of claim 3, wherein a rail groove that transversely penetrates is provided at the top surface of the power adapter, and the charging plug facing upward is vertically provided on a bottom surface of the rail groove.

6. The dual charging station of claim 5, wherein an earphone plug is further provided at the bottom surface of the rail groove of the power adapter; and the earphone plug and the charging plug are arranged in a line on the bottom surface of the rail groove.

7. The dual charging station of claim 6, wherein an arrangement order of the charging plug and the earphone plug on one power adapter is opposite to that on the other power adapter; and the two rail grooves extend in parallel with each other.

8. The dual charging station of claim 3, wherein a rail groove that transversely penetrates is provided at a top surface of the power adapter; the charging plug is located on an inner side wall of the rail groove, and the two rail grooves extend in parallel with each other.

9. The dual charging station of claim 1, wherein a bottom surface of the base is provided with an anti-slip pad respectively at four corners.

10. The dual charging station of claim 1, wherein a side wall of the base is provided with two charging indicator lights electrically connected to the circuit board; each of the two charging indicator lights is configured to indicate a charging state of the corresponding power adapter; and another side wall of the base is provided with a power cable outlet hole through which the power cable passes.
